(19) United States
(12) Patent Application Publication
(10) Pub. No.: US 2019/0126304 A1
(43) Pub. Date: May 2, 2019

(54) DRY PROOF FOAMER PUMP

(71) Applicant: RIEKE PACKAGING SYSTEMS LIMITED, Leicester (GB)

(72) Inventor: Yen Kean LEE, Rohnert Park, CA (US)

(21) Appl. No.: 16/096,732

(22) PCT Filed: Apr. 19, 2017
(86) PCT No.: PCT/EP2017/059278

§ 371 Date: Oct. 26, 2018

Related U.S. Application Data
(60) Provisional application No. 62/329,231, filed on Apr. 29, 2016.

(51) Int. Cl. B05B 11/00; B05B 15/50

(52) U.S. Cl. CPC B05B 11/0032; B05B 15/50; B05B 11/3087

(57) ABSTRACT

A foamer pump (22) for dispensing a liquid product from within a container with a foam consistency includes a collar (24) which is constructed and arranged for connection to said container, a pump engine received by the collar, including an actuator (28) having a nozzle orifice (34), and a seal panel (44) constructed and arranged for cooperating with the nozzle orifice to engage the nozzle orifice when the actuator is in an up position.

### BACKGROUND

Dispensers for flowable product are offered in a variety of constructions for handling a variety of products. Dispensers for flowable product may be constructed and arranged with a trigger sprayer mechanism or with a squeeze bottle or even as an aerosol. Perhaps the most popular styles of flowable product dispensers are those which include a pump engine, typically constructed so as to dispense the product with a foam consistency.

A typical style of pump engine for flowable product dispensers is operated based on axial movement of an actuator in a downward direction (i.e. toward a cooperating container). The actuator may also be referred to as a plunger for the pump engine.

As the actuator is depressed (i.e. moved in a downward direction), the interior of the cooperating container is pressurized which in turn drives the pump engine and results in the delivery of liquid product to the dispensing outlet or nozzle orifice of the dispenser. When the pump engine of the dispenser is constructed and arranged to dispense the flowable product as a foam or with a foam consistency, the pressurizing of the interior of the container causes the delivery of both liquid product and air into a mix chamber or region and from there through a mesh insert or screen, prior to dispensing from a nozzle orifice or similar structure.

A variety of products may be dispensed from a pump engine of the type described wherein that product is dispensed with a foam consistency. For example, products such as liquid soap and shaving cream are often dispensed from this type of pump engine with a foam consistency. Further, it has been recognized that it is possible that some of the foam product, intended to be dispensed, will be left around the dispensing nozzle orifice and may be left around or on other portions of the pump engine, such as being left on the mesh screen which is responsible for aeration and foam production. This foam which may be left around the dispensing nozzle orifice or on the mesh screen or in other locations is referenced herein as “residual foam”.

None of these residual-foam situations are typically of concern if the foam dispenser is used on a regular basis. With regular use, such as daily use, the next or subsequent dispensing cycle tends to loosen and purge at least a majority of any residual foam which was left behind from the prior dispensing cycle. Whether this residual foam was left around the nozzle orifice, in some passageway or on a mesh screen, the next dispensing cycle would likely purge most if not all of that residual foam. It is noted though that this next dispensing cycle may very likely leave its own residual foam on one or more of those same structures or surfaces.

If the foam dispenser is not used on a regular basis there is a risk that those residual foam deposits, with prolonged exposure to (dry) air, will dry out. The period of time which may be required for residual foam deposits such as on the nozzle orifice and mesh screen to dry up to a point where they cannot be purged during the next dispensing cycle will vary depending on the amount of residual foam, it is moisture content, the nature of the ambient air and obviously the length of time between dispensing cycles. As any residual foam tends to dry up or at least has its moisture content diminished, it becomes more solid in form and less likely to be removed during the next dispensing cycle. If these residual foam deposits are allowed to dry up to the point that they cannot be purged during the next dispensing cycle, then there are performance issues associated with the corresponding foam dispenser.

One performance issue to be anticipated relates to the nozzle orifice. When dried product is present, there can be an increased force required to operate the pump engine in order to purge out the dried product. This can result in the jetting of foam product and an irregular foam dispensing profile due to partial blockage of the nozzle orifice.

Another performance issue to be anticipated is perhaps more critical and this relates to having a clogged mesh screen. Depending on the extent and area of blockage due to residual foam and depending on how solid the dried product may have become, the mesh screen may no longer be capable of creating foam from the liquid product within the container.

A design improvement for the performance issues outlined above is offered by the exemplary embodiments of the present invention. Two embodiments are disclosed which offer different aesthetics, but the basic construction of a seal panel in order to prevent dry out of the foam product (i.e. residual foam) is similar for each exemplary embodiment, as described herein.

General aspects of our proposals are set out in the claims. In some general aspects herein a pump, such as especially a foamer, for dispensing a liquid product from within a container with a desired consistency comprises an actuator having a nozzle orifice and movable between an up position (usually the rest position) and a down position; and a seal panel or nozzle seal platform is provided so as engage and close the nozzle orifice when the actuator is in the up position. When the actuator moves to the down position the nozzle orifice moves clear of the seal panel or seal platform to be open or unobstructed for dispensing.

A seal panel may slide across the nozzle orifice to cover it and/or scrape any residual product. A seal panel may contact around the edge of the nozzle orifice in the actuator up position. The seal panel may be biased towards the nozzle orifice, such as by being deflected away from a rest position (defined by the seal platform) by the actuator in or approaching the up position. An upper edge of the nozzle orifice and or lower edge of the seal panel may be shaped with a bevel to assist deflection. A seal platform may be mounted on or formed integrally with a collar which connects the pump to a container e.g. by an internal thread thereof. The seal platform may have one or more upstanding arms supporting a seal panel to be deflectable, against a biasing force provided by the seal platform, towards the nozzle orifice in the actuator up position. The one or more arms are arranged for the nozzle orifice to be open and unobstructed when moved to below the seal panel.

### SUMMARY

A dry proof foamer pump, as described herein, addresses the foamer pump concern of product drying out when products such as foam shaving cream and foamed liquid soap, each dispensed with the foam consistency, leave behind residual foam. Even with normal use of the foam dispenser, it is possible for residual foam to remain around the nozzle orifice and to remain on the mesh screen. It is anticipated that the flow of foam product during a dispensing cycle will clear the majority of the residual foam from the prior dispensing cycle, while still depositing its own residual foam.

When the foam dispenser is not used regularly (i.e. when there is infrequent use), it is anticipated that at least some portion of the residual foam will dry out if exposed to (dry) air for a sufficient length of time. Obviously, the design of the foam dispenser cannot dictate or control the frequency of use by the purchaser. However, in order for the residual foam to dry out it must be exposed to air. In order to be clear, this is dry air which has a drying effect or capability as contrasted to moisture saturated air which would have much less effect on residual foam.

The exemplary embodiments of the present invention provide a seal panel which is constructed and arranged to close off the open face of the nozzle orifice. This nozzle orifice or opening is essentially the only location for the introduction of (dry) air as all other interfaces which are exposed to the atmosphere are presumed to be adequately closed or sealed.

There is an important design consideration for the exemplary embodiments of the present invention. The nozzle seal needs to be an “active seal”. The definition of “active” seal as used herein is a sealing mechanism which is not driven by liquid flow. In other words, the nozzle seal needs to be opened up prior to the discharge of foam and otherwise remain actively engaged as a seal. This is an important feature because foam tends to break down into liquid when there are blockages in the fluid path.

The exemplary embodiments of the present invention each present a dry proof foamer pump construction which includes a nozzle seal platform which is aligned with the corresponding pump nozzle orifice and which provides a close fit over the nozzle orifice so as to close off the orifice face from the intrusion of ambient air. While the nozzle seal platform is constructed and arranged to be generally stationary, the construction is such, based on its overall size, shape and material selection, that it will have some flexibility which helps to maintain a biased seal (i.e. active seal) sufficient to close off the nozzle orifice from the intrusion of ambient air.

Upon downward depression of the actuator associated with the pump engine, i.e. on the downstroke, the nozzle opens up to allow the dispensing of foam. During the spring-biased return of the actuator on the upstroke, to its starting position, the (generally stationary) seal platform functions as a scraper to scrape off residual foam on the face of the nozzle orifice. The nozzle seal platform provides a contacting surface which is biased against the outer surface of the nozzle orifice and which remains as a seal panel against the face of the nozzle orifice so as to close off that orifice from the intrusion of ambient air.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a dry proof foamer pump, in an actuator up position, according to an exemplary embodiment of the present invention.

FIG. 2 is a perspective view of the FIG. 1 dry proof foamer pump.

FIG. 3 is a right side elevational view of the FIG. 1 dry proof foamer pump.

FIG. 4 is a left side elevational view of the FIG. 1 dry proof foamer pump.

FIG. 5 is a rear elevational view of the FIG. 1 dry proof foamer pump.

FIG. 6 is a front elevational view of the FIG. 1 dry proof foamer pump.

FIG. 7 is a right side elevational view, in full section, of the FIG. 1 dry proof foamer pump.

FIG. 8 is a top plan view of the FIG. 1 dry proof foamer pump.

FIG. 9 is a bottom plan view of the FIG. 1 dry proof foamer pump.

FIG. 10 is a perspective view of the FIG. 1 dry proof foamer pump, in an actuator down position.

FIG. 11 is a left side elevational view of the FIG. 10 dry proof foamer pump.

FIG. 12 is a front elevational view of the FIG. 10 dry proof foamer pump.

FIG. 13 is a perspective view of a collar and nozzle seal platform combination which comprises one part of the FIG. 1 dry proof foamer pump.

FIG. 14 is a perspective view of a collar and nozzle seal platform combination which comprises one part of the FIG. 1 dry proof foamer pump.

FIG. 15 is a perspective view of a dry proof foamer pump, in an actuator up position, according to another exemplary embodiment of the present invention.

FIG. 16 is a perspective view of the FIG. 15 dry proof foamer pump.

FIG. 17 is a right side elevational view of the FIG. 15 dry proof foamer pump.

FIG. 18 is a left side elevational view of the FIG. 15 dry proof foamer pump.

FIG. 19 is a rear elevational view of the FIG. 15 dry proof foamer pump.

FIG. 20 is a front elevational view of the FIG. 15 dry proof foamer pump.

FIG. 21 is a top plan view of the FIG. 15 dry proof foamer pump.

FIG. 22 is a bottom plan view of the FIG. 15 dry proof foamer pump.

FIG. 23 is a perspective view of the FIG. 15 dry proof foamer pump, in an actuator down position.

FIG. 24 is a left side elevational view of the FIG. 23 dry proof foamer pump.

FIG. 25 is a front elevational view of the FIG. 23 dry proof foamer pump.

FIG. 26 is a perspective view of a collar and nozzle seal platform combination which comprises one part of the FIG. 15 dry proof foamer pump.

FIG. 27 is a perspective view of a collar and nozzle seal platform combination which comprises one part of the FIG. 15 dry proof foamer pump.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

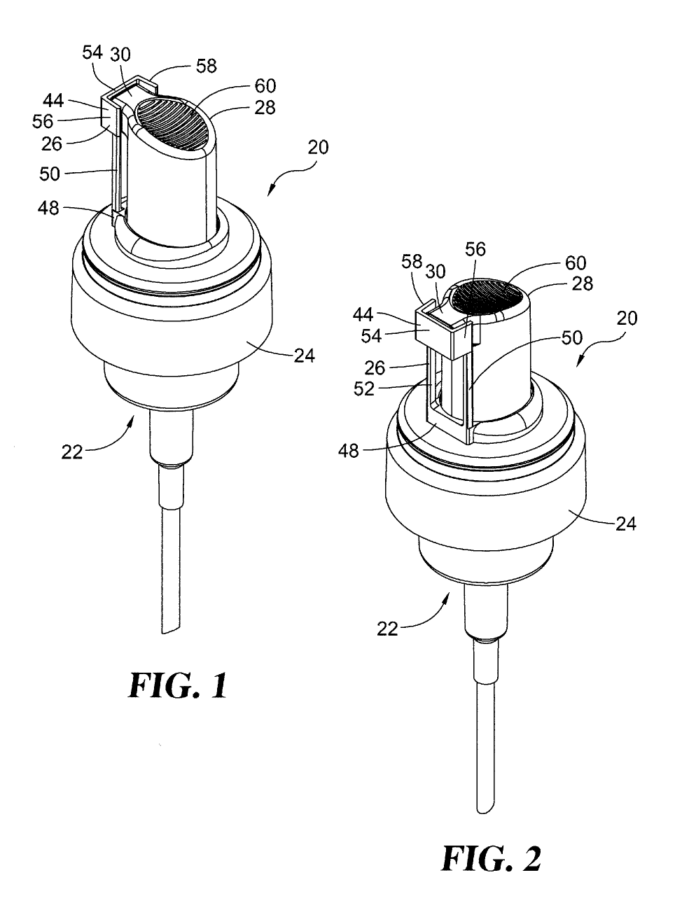

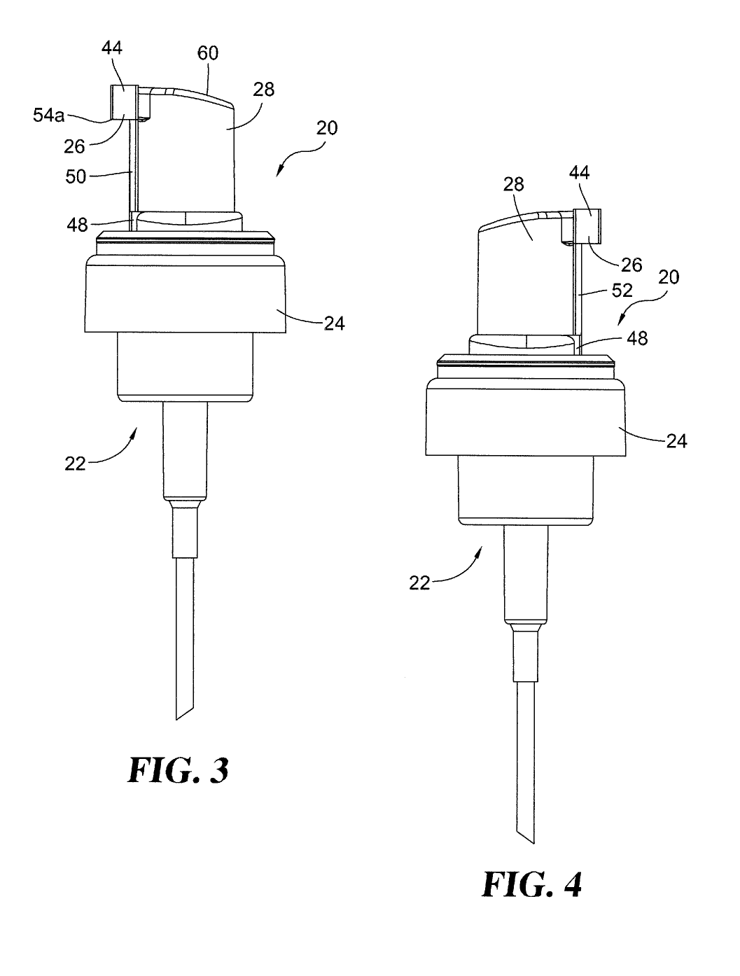

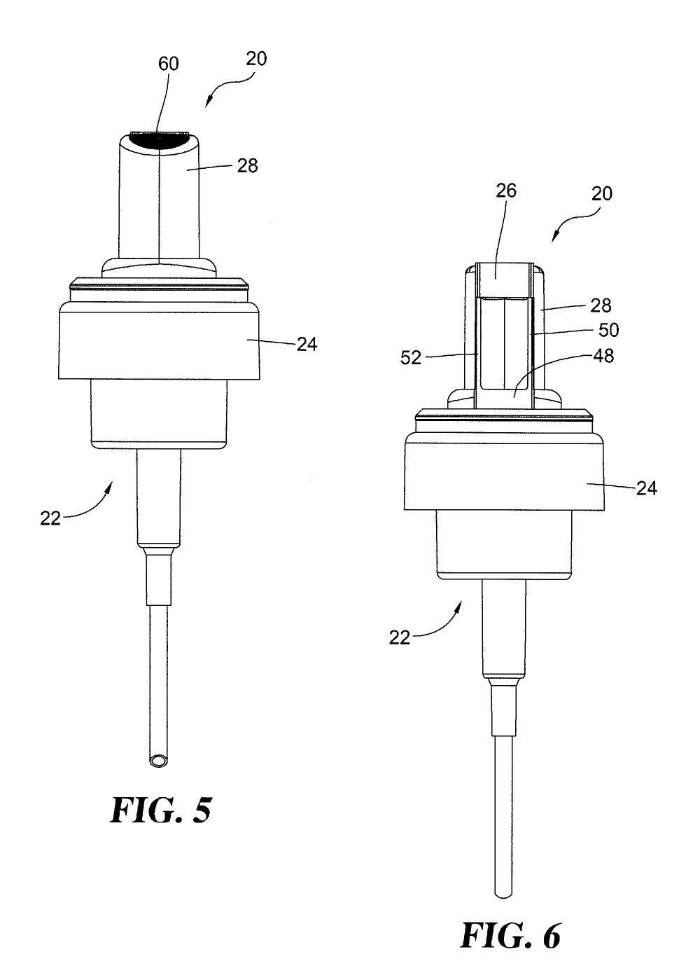

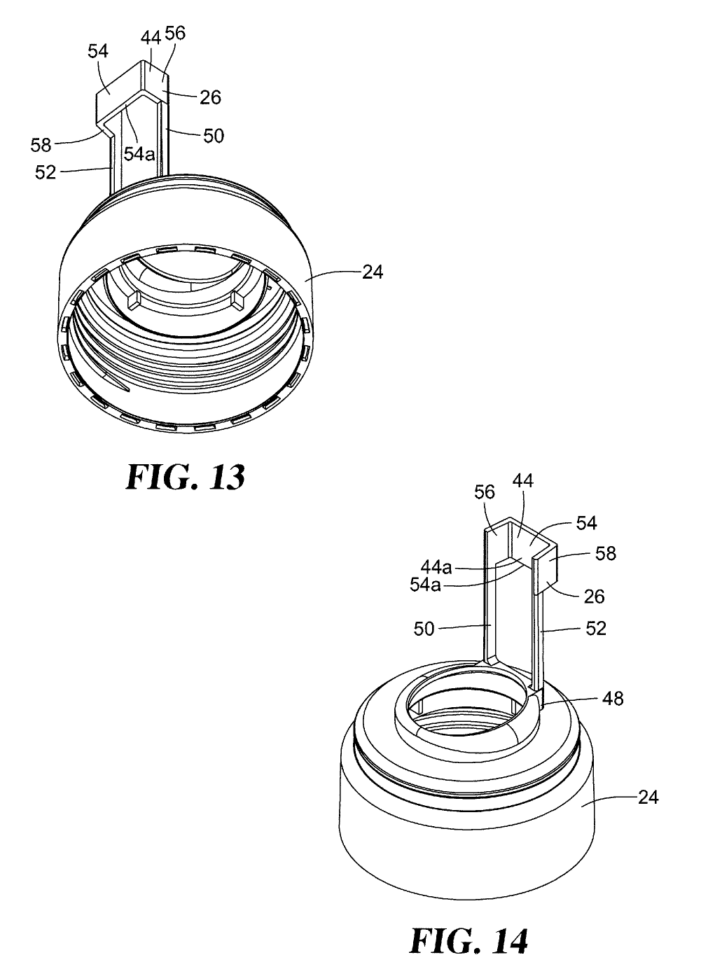

Referring to FIGS. 1-6, there is illustrated a dry proof foamer pump 20 which is constructed and arranged according to a first embodiment of the present invention. As should be understood, foamer pump 20 is used by connection to a container which is holding a supply of foaming liquid. Foamer pump 20 includes a pump engine 22, collar 24 and nozzle seal platform 26. It is the internally-threaded collar 24 which threads to the threaded neck of the cooperating container, according to the exemplary embodiments. The pump engine 22 includes actuator 28 which is to be manually moved in a downward direction (i.e. in the direction of the bottom of the container) in order to perform a dispensing cycle of the liquid product within the container. The collar 24 and nozzle platform 26 are preferably molded of plastic as a single-piece component or combination (see FIGS. 13 and 14). Alternatively, collar 24 and the platform 26 may be individually molded as separate, single-piece components and may be joined together into the illustrated combination by either a snap-fit assembly of the two or by ultrasonic welding together of the two components or by similar techniques. The final appearance from either approach, is generally consistent with what is illustrated in FIGS. 13 and 14. What is important is that the nozzle seal platform 26 be secured, or anchored in some fashion, to the collar 24 so that there is the requisite support and stability for the platform 26 and to enable its biased condition against the nozzle orifice of the actuator as described herein.

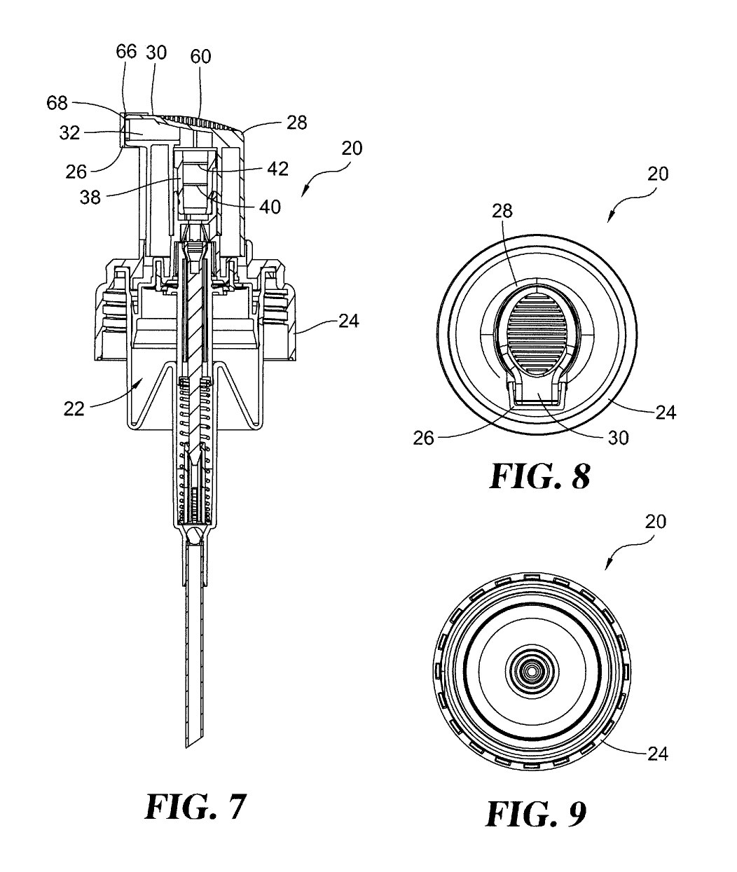

Actuator 28 includes a dispensing nozzle 30 which defines a flow passageway 32 ending in a nozzle orifice 34 which includes an exposed face in the form of outer surface 36. As illustrated in FIG. 7, except for the presence of nozzle seal platform 26, nozzle orifice 34 is open to ambient air which would presumably reach any residual foam in flow passageway 32 or around orifice 34 as well as any residual foam found on or around the mesh insert 38.

Mesh insert 38 includes a coarse screen 40 and a fine screen 42 and either one or both screens can show signs of having residual foam as being left on these surfaces or structures from a completed dispensing stroke or cycle. With the nozzle orifice 34 being open to ambient air means that unless foamer pump 20 is used on a regular basis, these locations of residual foam may dry out and ultimately cause performance issues for the foamer 20.

The exemplary embodiments which are disclosed herein include the addition of the nozzle seal platform 26 in order to close over the outer surface 36 of the nozzle orifice 34 and thus physically close off the nozzle orifice 34 and its passageway 32 from the intrusion of ambient air. Assuming that there is adequate contact pressure between the seal panel 44 of platform 26 and outer surface 36, in the form of biased engagement of panel 44 up against outer surface 36, the intrusion of ambient air will be minimized and ideally excluded. Without contact by (dry) ambient air, any residual foam left on surfaces within the pump engine 22, such as orifice 34, passage 32, and mesh insert 38, will not dry out or at least will not dry out to the extent that it cannot be purged with the next dispensing cycle.

The biased engagement between seal panel 44 and outer surface 36 is the result of sizing and shaping of platform 26 relative to nozzle 30 such that in the FIG. 1 condition with the actuator in an up position, the seal panel 44 is pushed outwardly by surface 36 in that they are constructed and arranged to essentially occupy the same space. Pushing outwardly on seal panel 44 creates a biased return force wherein panel 44 attempts to return to its static position. Being displaced from its normal position causes the seal panel 44 to exert a spring biased force against outer surface 36. The slight displacement causes the seal panel 44 to deflect outwardly, effectively being hinged at its point of contact or anchoring relative to collar 24. Pivoting about that point of contact as it deflects outwardly establishes the spring biasing force. The level or the degree of abutment engagement by panel 44 up against surface 36 needs to be sufficient to close off the interior of the nozzle orifice from ambient air. In this regard it is important that the nozzle orifice have a substantially flat outer surface and that seal panel 44 have a substantially flat surface which would effectively cover or close over the entirety of the outer surface 36 of nozzle orifice 34.

With continued reference to FIGS. 13 and 14, the nozzle seal platform 26 includes a base 48 as the point of contact or as the connection interface with collar 24. The platform 26 needs to be securely connected, assembled, anchored or joined to the collar 24 as this is the location which is stressed by the outwardly flexing of panel 44 away from the actuator due to the level or degree of interference. Considering the construction of platform 26 and its point of connection to collar 24, the panel 44 should assume a position which will be occupied by the outermost surface of nozzle 30. Since panel 44 and orifice 34 cannot occupy the same space, the panel 44 is pushed outwardly and the elasticity of the platform 26 creates a biasing force which tends to draw the panel 44 back up against the outer surface 36 of orifice 34. This is the biasing of panel 44 which closes off the nozzle 30 to ambient air.

The platform 26 also includes a pair of opposed arms 50 and 52 which extend in between and connect the base 48 and the panel 44. Panel 44 has a substantially rectangular center wall 54 and side walls 56 and 58 to create a type of block U shape. Arm 50 is joined to wall 56 and arm 52 is joined to wall 58. As mentioned, the platform 26 may be a molded plastic, single-piece component or may be fabricated with collar 24, together forming a molded plastic, single-piece combination. It is center wall 54 which is designed to be biased against the outer surface 36 of orifice 34 in order to close off ambient air from the interior of nozzle 30. The platform 26 is biased against the outer surface 36 of the nozzle orifice in FIGS. 1-9 with the actuator in an up position, at the top of the downstroke, ready for a dispensing cycle.

In terms of directions and orientations, it is being assumed for the purposes of this disclosure that the dry proof foamer pump 20 is being used in an upright position as if placed on a substantially horizontal counter or similar surface. The closed bottom of the selected container would represent the lower surface while the threaded neck of the container would represent an upper location or feature. Therefore, an up direction constitutes a direction moving from the base of the container in the direction of the neck of the container. A down direction or down condition would be movement from the neck of the container in the direction of the bottom of the container. With the foamer pump arranged in a conventional manner on a generally horizontal surface, downward movement would be in the direction of gravity while an outer movement would be lateral or generally parallel with the bottom of the container or countertop. An inward direction would be the opposite or reverse of an outward direction and would be movement in a generally horizontal direction toward the center or axial centerline of the pump engine 22 and the corresponding container.

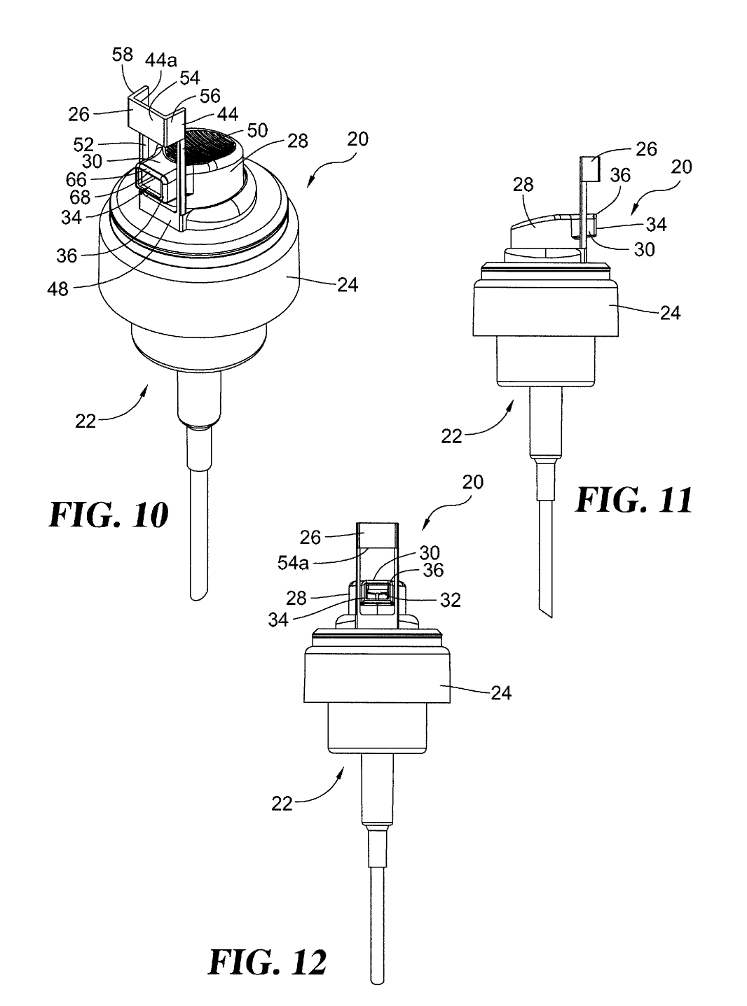

When the foamer pump 20 is to be used, the user pushes down on the upper surface 60 of actuator 28, moving the actuator 28 from its up position toward its down position of FIGS. 10-12. The position of actuator 28 in FIGS. 10-12 represents the conclusion or endpoint of actuator 28 (downstroke) travel for its dispensing stroke. What has occurred by this actuator travel is to slide the outer surface 36 of nozzle orifice 34 out of engagement with the inner surface 44a of panel 44, specifically moving it out of engagement with center wall 54. The level of downward actuation force which is applied for the dispensing downstroke, i.e., the action downstroke, is greater than the biasing force tending to pull panel 44 back up against outer surface 36. There is though a sliding action as panel 44 and outer surface 36 come out of engagement (see FIGS. 10-12). Since there is intended to be a full surface-to-surface abutment between panel 44 and nozzle 30, specifically between center wall 54 and outer surface 36, there is no exposed edge, raised surface, interfering corner or raised rib which might interfere with free sliding motion of the outer surface 36 as it slides across center wall 54 during the downstroke of actuator 28.

At the conclusion of the dispensing downstroke of actuator 28 as illustrated in FIGS. 10-12, the spring 62 of the pump engine biases the actuator 28 to return to its up position once the manual force on the actuator is released. This is the normal or conventional action for a spring-biased pump engine wherein an actuator is downwardly depressed by manual interaction from the user for dispensing a volume of liquid product, in this case with a foam consistency, and then the actuator returns automatically to its starting up position due to the spring action of the pump engine.

As the actuator 28 travels (i.e. returns) from its down position of FIGS. 10-12 to its up position of FIGS. 1-7, the outer surface 36 moves in the direction of the lower edge 54a of center wall 54. There is a necessary close sizing between outer surface 36 and center wall 54 so that there will be a modest spring-biased contact to close off ambient air from intrusion into nozzle orifice 34. When the outer surface 36 disengages from center wall 54, the slight biasing force from deflecting of arms 50 and 52 relative to base 48 which is fixed to collar 24, the center wall 54 as part of seal panel 44 deflects or pivots slightly inwardly in an inward or radial direction so that panel 44 now essentially occupies the space previously occupied by outer surface 36.

In order to prevent interference between outer surface 36 and center wall 54 which might occur on the upstroke travel of actuator 28, the upper edge 66 of nozzle orifice 34 is shaped with a bevel 68 (see FIG. 10) which slants upwardly as it extends radially inwardly. The size of this bevel 68 presents an edge 66 which is large enough to provide the requisite clearance between outer surface 36 and center wall 54. In other words, the uppermost edge of bevel 68 does not interfere with the position of center wall 54 while the lower edge of bevel 68 will interfere with outer wall 54. The actual point of cross over from clearance to interference is somewhere along the surface of the bevel between its upper edge and lower edge. The initial point or line of engagement between the nozzle 30 and the platform 26 is at this inner edge of bevel 68 4as it initially clears and then quickly contacts lower edge 54a. With continued upward travel of actuator 28, the force vectors due to the angled surface provided by bevel 68 push outwardly on center wall 54 which causes the platform 26 to pivot radially outwardly around base 48 which is fixed in some fashion to the collar 24. The spring force of the pump engine is sufficient to use the nozzle 30 of actuator 28 as the component to push outwardly on platform 26. At the end of the upstroke of actuator 28, the outer surface 36 of the nozzle orifice 34 is closed off by center wall 54 such that the liquid product and any residual foam are not exposed to ambient air which could dry out the residual foam in the event of infrequent use of the pump engine 22. Returning the foamer pump 22 its FIG. 1 orientation reestablishes the slight spring biased abutment or engagement force of center wall 54 up against outer surface 36, effectively closing off ambient air from intrusion into nozzle 30. The dispensing process, including the described actuator travel as well as its disengagement and re-engagement with seal panel 44, repeats itself with each subsequent dispensing stroke, continuing to use platform 26 to close off ambient air and prevent dry out of residual foam.

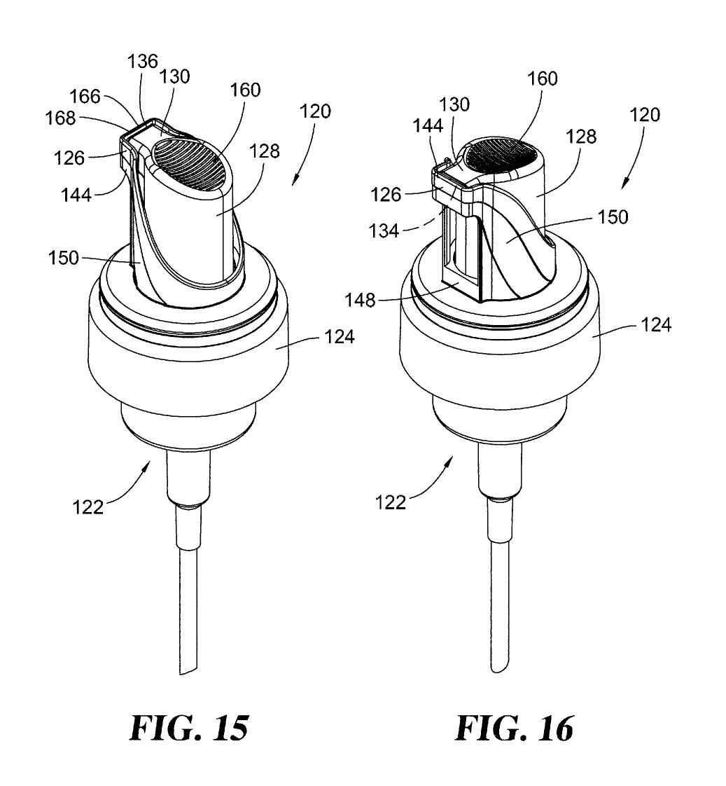

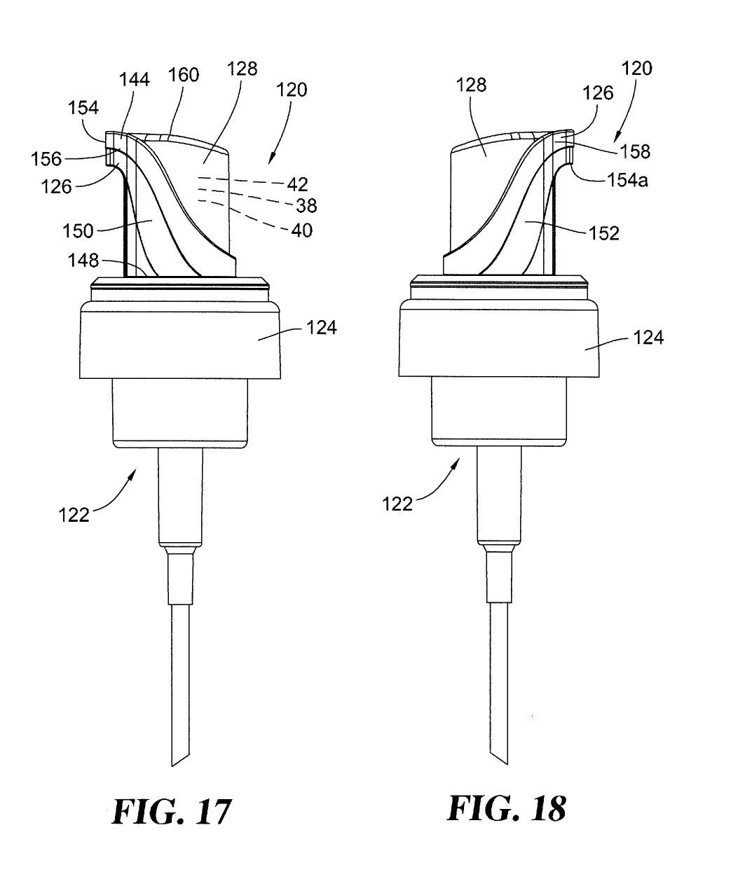

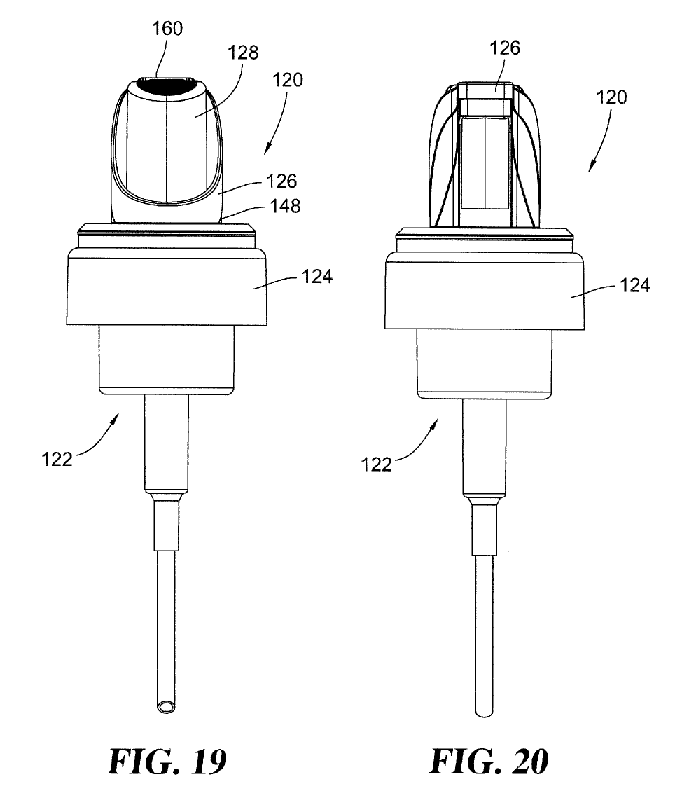

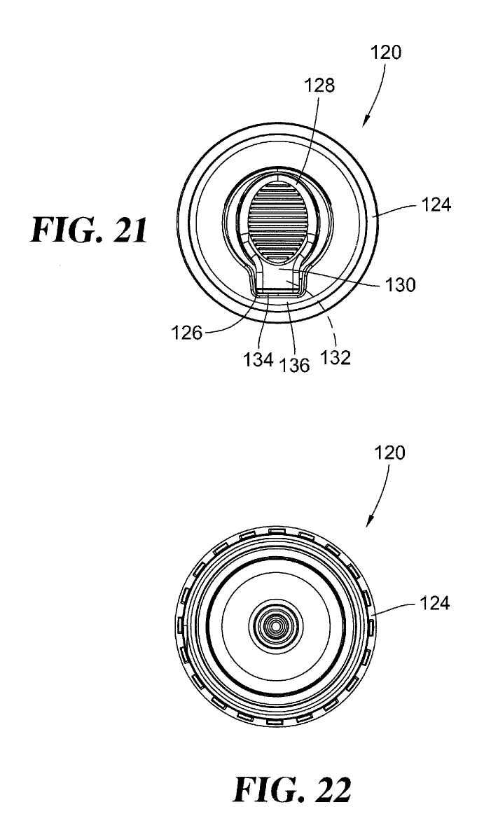

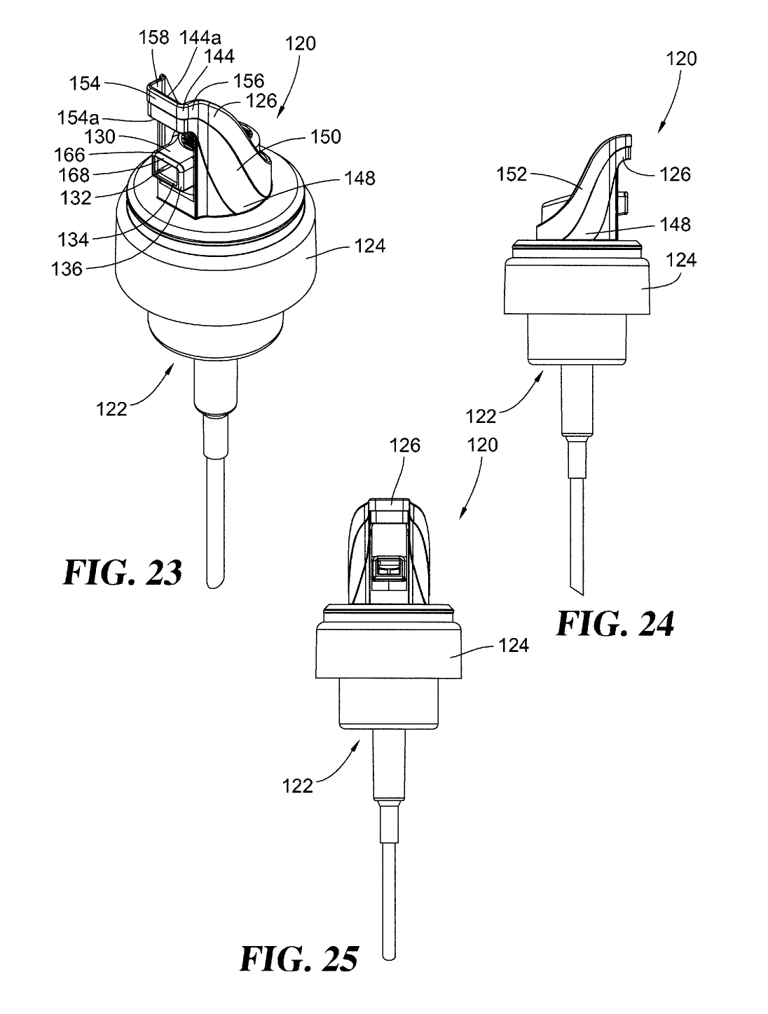

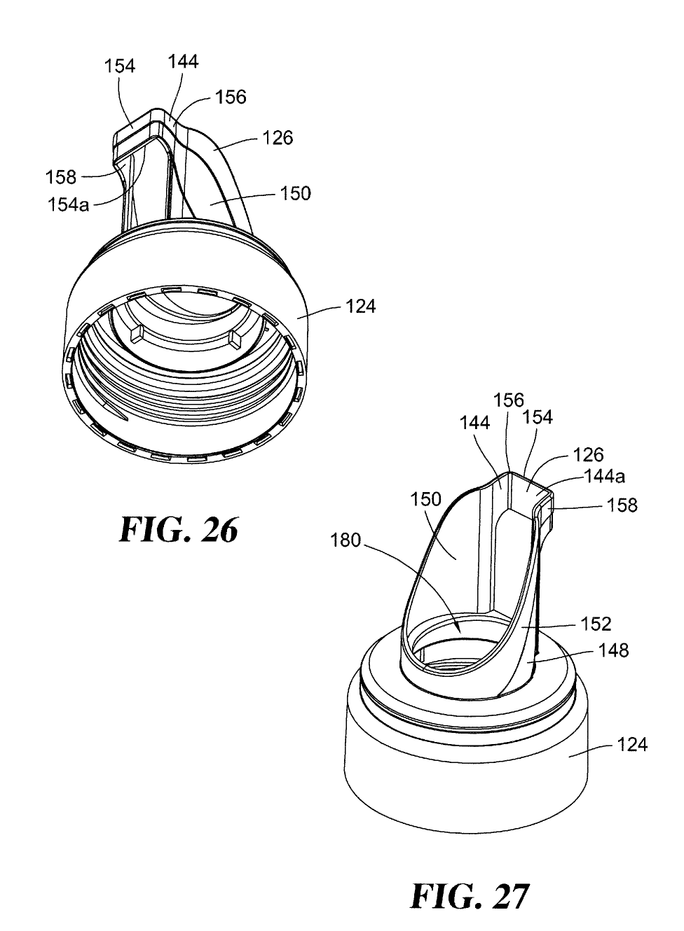

With reference to FIGS. 15-27, another dry proof foamer pump 120 is disclosed. With the exception of the aesthetic styling, shaping and arrangement of nozzle seal platform 126, as compared to nozzle seal platform 26, this second exemplary embodiment as represented by foamer pump 120 is the same as foamer pump 20, both structurally and functionally. For reinforcement of the fact regarding the structural and functional similarities between foamer pump 120 and foamer pump 20, the number 100 has been added, for all like parts and features, to the reference number of each corresponding structural feature of the first embodiment. Although the styling of platform 126 is different from platform 26 as is readily apparent from a visual comparison of FIGS. 13 and 14 with FIGS. 26 and 27, the same numbering scheme has been used, albeit with the 100 prefix, as the same structural parts are present, simply with a different styling.

With continued reference to FIGS. 26 and 27, collar 124 is constructed and arranged essentially the same as collar 24, except for the integration of nozzle seal platform 126 and the style of base 148 as contrasted to base 48. The arms 50 and 52 of platform 26 now have a larger curved shape in the form of arms 150 152, extending completely around opening 180 and being integrally joined, as is illustrated.

In view of the one-piece construction of platform 126 there is no specific boundary line to be drawn so as to visually separate seal panel 144 from arms 150 and 152 and from base 148. The center wall 154 still has the same shape and same positioning as center wall 54, an important feature since the actuator 128 and the remainder of the pump engine 122 have not changed or been altered in comparison to actuator 28 and pump engine 22. The only difference between the two exemplary embodiments of FIGS. 1 and 15 is the aesthetic styling, shaping and arrangement of nozzle seal platform 126 as compared to nozzle seal platform 26.

In terms of functioning, center wall 154 is still biased up against outer surface 136 of nozzle orifice 134 by the slight deflection caused by the outer surface 136 pushing radially outwardly on center wall 154 when the actuator 128 is in the up position and ready for the dispensing downstroke. In the same manner as with foamer pump 20, the actuation of the dispensing stroke moves actuator 128 in a downward direction where the outer surface 136 slides across the inner surface of center wall 154. Before any actual foam product is dispensed, the nozzle orifice 134 has cleared center wall 154 as part of the downward travel such that the nozzle orifice 134 is fully open and unobstructed by any overlap with center wall 154.

On the upstroke of actuator 128, the upper edge 166 which includes bevel 168 is constructed and arranged so that there is no abutment with seal panel 144 which would interfere with the spring biased return of the actuator 128. The upper edge 166 of the nozzle orifice 134 initially clears the lower edge 154a of center wall 154. As the ramped or inclined surface of the bevel 168 comes into contact with lower edge 154a, two things occur. First, the seal panel 144 is deflected outwardly, creating a spring biasing force of the center wall 154 against the outer surface 136. Secondly, there is a scraping action due to the sliding movement and surface-to-surface biased engagement. This scraping action is of the lower edge 154a across the outer surface 136. This action scrapes off any residual foam and thereafter provides a suitable surface-to-surface engagement between the inner surface of center wall 154 and the outer surface 136 of nozzle orifice 134. This surface-to-surface engagement between these components effectively closes off ambient air which might otherwise dry out any locations of residual foam. This description of operation is essentially the same for foamer pump 20 as it is for foamer pump 120.

In addition to the structural elements already identified relative to foamer pump 120, foamer pump 120 also includes dispensing nozzle 130, flow passage 132, mesh insert 138, coarse screen 140, fine screen 142, inner surface 144 a, point of contact 146, side wall 156, side wall 158 and upper surface 160.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A pump for dispensing a liquid product from within a container with a desired consistency, said pump comprising:
a collar which is constructed and arranged for connection to said container; a pump engine received by said collar, including an actuator having a nozzle orifice; and
a seal panel constructed and arranged for cooperating with said nozzle orifice to engage said nozzle orifice when said actuator is in an up position.

2. The pump of claim 1 wherein said seal panel is part of a nozzle seal platform which is constructed and arranged to place a biasing force against an outer surface of said nozzle orifice during engagement.

3. The pump of claim 2 wherein said nozzle seal platform is supported by said collar.

4. The pump claim 1 wherein said nozzle orifice is moved out of engagement with said seal panel during downstroke movement of said actuator.

5. The pump of 1 wherein said nozzle orifice includes an upper edge which is shaped with a bevel.

6. The pump of 1 wherein said nozzle orifice includes a front surface which is closed off by the engagement of said seal panel when said actuator is in an up position.

7. The pump of claim 6 wherein said seal panel is constructed and arranged to effect a scraping action across said front surface during actuator travel upwardly.

8. A pump for dispensing a liquid product from within a container with a desired consistency, said pump comprising:
a collar which is constructed and arranged for connection to said container;
a pump engine received by said collar, including an actuator having a nozzle orifice; and
a nozzle seal platform supported by said collar and cooperating with said nozzle orifice to engage said nozzle orifice when said actuator in an up posit ion.

9. The pump of claim 8 wherein said nozzle seal platform includes and is supported by a first portion cooperating with said collar and further includes a second portion which is spaced apart from said first portion and is constructed and arranged for engaging said nozzle orifice.

10. The pump of claim 9 wherein said first portion and said second portion are connected to each other by an arm.

11. The pump of claim 10 wherein said nozzle seal platform is a single-piece component.

12. The pump of claim 11 wherein said nozzle seal platform is integrally combined with h said collar such that said nozzle seal platform and said collar are combined as a single-piece component.

13. The pump claim 8 wherein said nozzle orifice includes an upper edge which is shaped with a bevel.

14. The pump claim 8 wherein said nozzle orifice includes a front surface which is closed off by engagement of said nozzle seal platform when said actuator is in an up position.

15. The pump of claim 14 wherein said nozzle seal platform is constructed and arranged to effect a scraping action across said front surface during actuator travel upwardly.

16. A nozzle seal platform for use in conjunction with a pump which is constructed and arranged for dispensing a liquid product from within a container with a desired consistency, said pump including a collar and a pump engine received by said collar and further including an actuator with a nozzle orifice, said nozzle seal platform comprising:
a base constructed and arranged for securing said nozzle seal platform to said collar;
a seal panel constructed arrange for closing off said nozzle orifice when said actuator is in an up position; and
an arm connecting said seal panel to said base.

17. The nozzle seal platform of claim 16 wherein said seal panel is constructed and arranged for scraping across said nozzle orifice to remove residual product during actuator travel upwardly.

18. The nozzle seal platform of claim 16 wherein said nozzle seal platform is a molded plastic, single-piece component.
